(19) United States
(12) Patent Application Publication
(10) Pub. No.: US 2015/0380154 A1
(43) Pub. Date: Dec. 31, 2015

(54) POWER SUPPLYING SIDE COIL AND CONTACTLESS POWER SUPPLYING APPARATUS

(71) Applicant: Yazaki Corporation, Tokyo (JP)

(72) Inventors: Kazuyoshi Kagami, Susono-shi (JP); Shingo Tanaka, Yokosuka-shi (JP); Hajime Terayama, Susono-shi (JP)

(21) Appl. No.: 14/848,832

(22) Filed: Sep. 9, 2015

Related U.S. Application Data
(63) Continuation of application No. PCT/JP2014/056170, filed on Mar. 10, 2014.

(30) Foreign Application Priority Data
Mar. 11, 2013 (JP) 2013-047733

(51) Int. Cl. H01F 27/28; H01F 38/14

(52) U.S. Cl. CPC H01F 27/2823; H01F 38/14

(57) ABSTRACT

A power supplying side resonant coil contactlessly supplies power to a power receiving side resonant coil. The power supplying side resonant coil includes a first power supplying side coil unit and a second power supplying side coil unit disposed side by side on the same axis. The first power supplying side coil unit and the second power supplying side coil unit are opposite to each other in the direction of winding.

### TECHNICAL FIELD

The present invention relates to a power supplying side coil and a contactless power supplying apparatus, especially, a power supplying side coil used for a contactless power supplying and a contactless power supplying apparatus that includes the power supplying side coil.

### BACKGROUND ART

In recent years, as a power supplying apparatus for supplying power to a battery mounted on a hybrid vehicle and an electric vehicle, wireless power supplying has been focused that does not use a power supply cord and a power transmission cable. As one of the wireless power supplying technique, there is, for example, that of a resonant type (Patent Literatures 1 and 2).

In the resonant type power supplying apparatus, one of a pair of resonant coils electromagnetically resonant with each other is installed on the ground of a power supplying facility and the other is mounted on a vehicle, and power is contactlessly supplied from the resonant coil installed on the ground of the power supplying facility to the resonant coil mounted on the vehicle. Hereinafter, one of the resonant coil that is installed on the power supplying facility is referred to as a power supplying side resonant coil, and the other of the resonant coil that is mounted on the vehicle is referred to as a power receiving side resonant coil.

The resonant type power supplying apparatus described above has an advantage that power can be supplied wirelessly even when there is some distance between the power supplying side resonant coil and the power receiving side resonant coil. However, since there is the distance between the power supplying side resonant coil and the power receiving side resonant coil, there is a possibility that large electromagnetic leakage occurs around the coils.

### CITATION LIST

### Patent Literatures

Patent Literature 1: JP 2011-217596 A

Patent Literature 2: JP 2012-156281 A

SUMMARY OF INVENTION

### Technical Problem

Therefore, the present invention aims to provide a coil and a contactless power supplying apparatus that prevent electromagnetic leakage.

### Solution to Problem

The first aspect of the present invention for solving the problem described above is a power supplying side coil that contactlessly supplies power to a power receiving side coil, the supplying side coil including a first coil unit and a second coil unit disposed side by side on the same axis, and the first coil unit and the second coil unit are opposite to each other in the direction of winding, and a wire that configures the first coil unit and a wire that configures the second coil unit are different from each other in length.

The second aspect of the present invention is the power supplying side coil according to the first aspect in which the power supplying side coil and the power receiving side coil are disposed such that their center axes are vertical to a separation direction of the power supplying side coil and the power receiving side coil at the time of supplying power.

The third aspect of the present invention is the power supplying side coil according to the second aspect, in which the first coil unit and the second coil unit are different from each other in the number of turns.

The fourth aspect of the present invention is a contactless power supplying apparatus, including a power supplying side coil according to the first aspect, and a power receiving side coil to which power is contactlessly supplied from the power supplying side coil.

The fifth aspect of the present invention is a contactless power supplying apparatus, including a power supplying side coil according to the second aspect, and a power receiving side coil to which power is supplied from the power supplying side coil.

### Advantageous Effects of Invention

As described above, according to the first, fourth, and fifth aspects of the present invention, since the first coil unit and the second coil unit are wound in opposite directions to each other, electromagnetic fields leaked from the first and second coil units cancel each other, and a leakage magnetic field can be prevented. Further, since the wire that configures the first coil unit and the wire that configures the second coil are different from each other in length, it is possible to impart directivity to the leakage magnetic field.

According to the third aspect of the present invention, the lengths of the wires that configure the first coil unit and the second coil unit can be made to be different from each other by changing the number of turns.

### BRIEF DESCRIPTION OF DRAWINGS

FIG. 1 is a block diagram illustrating one embodiment of a contactless power supplying apparatus of the present invention;

FIG. 2 is a perspective view of a contactless power supplying apparatus illustrated in FIG. 1 in a reference example;

FIG. 3 illustrates a simulation result of a leakage magnetic field distribution for a reference product A that is a contactless power supplying apparatus illustrated in FIG. 2;

FIG. 4 is a perspective view of the contactless power supplying apparatus illustrated in FIG. 1 in a first embodiment;

FIG. 5 illustrates a simulation result of the leakage magnetic field distribution for a present invention product B that is a contactless power supplying apparatus illustrated in FIG. 4;

FIG. 6 is a perspective view of the contactless power supplying illustrated in FIG. 1 in a second embodiment;

FIG. 7 illustrates a simulation result of the leakage magnetic field distribution for a present invention product C that is a contactless power supplying apparatus illustrated in FIG. 6;

FIG. 8 is a graph illustrating a simulation result of the leakage magnetic field distribution for a conventional product that is a contactless power supplying apparatus in which a resonant coil is uniformly wound, and

FIG. 9 is a perspective view of the conventional product simulated in FIG. 8.

### DESCRIPTION OF EMBODIMENTS

### Reference Example

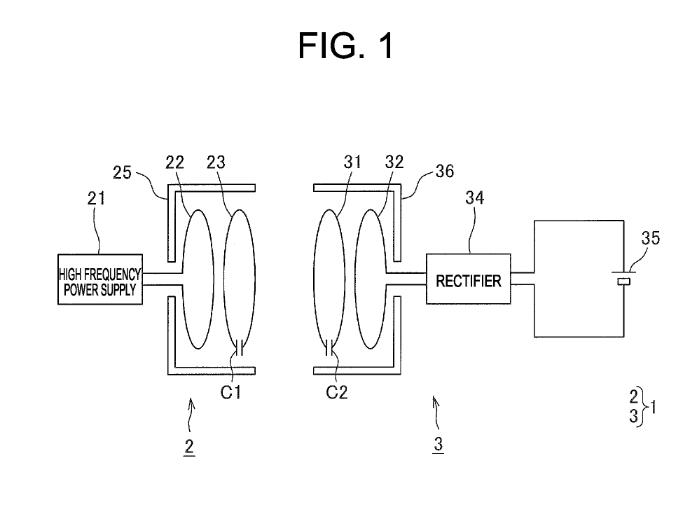

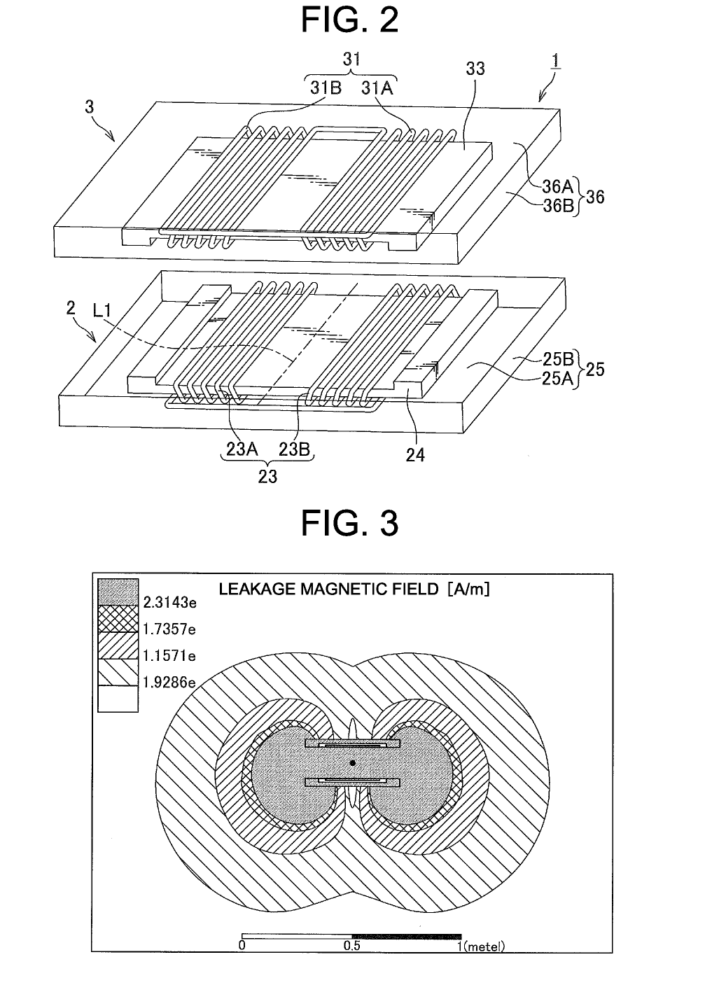

Hereinafter, a contactless power supplying apparatus in a reference example will be described with reference to FIG. 1 and FIG. 2. FIG. 1 is a block diagram illustrating one embodiment of a contactless power supplying apparatus of the present invention. FIG. 2 is a perspective view of a contactless power supplying apparatus illustrated in FIG. 1 in the reference example. As illustrated in FIG. 1, a contactless power supplying apparatus 1 includes a power supplying unit 2 provided in a power supplying facility, and a power receiving unit 3 mounted on a vehicle.

The power supplying unit 2, as illustrated in FIG. 1, includes a high frequency power supply 21 as a power supply, a power supplying side loop antenna 22 to which high frequency power from the high frequency power supply 21 is supplied, a power supplying side resonant coil 23 electromagnetically coupled with the power supplying side loop antenna 22, a power supplying side core 24 around which the power supplying side loop antenna 22 and the power supplying side resonant coil 23 are wound (see FIG. 2), a power supplying side capacitor C1 connected across both ends of the power supplying side resonant coil 23, and a power supplying side shield case 25 for housing the power supplying side loop antenna 22 and the power supplying side resonant coil 23.

The high frequency power supply 21 generates the high frequency power to supply the power to the power supplying side loop antenna 22. The high frequency power to be generated by the high frequency power supply 21 is provided so that the frequency is equal to a resonant frequency (for example, 13.56 MHz) of the power supplying side resonant coil 23 and the power receiving side resonant coil 31 to be described later.

The power supplying side loop antenna 22, although not illustrated in FIG. 2, is configured by winding a conductive wire around the power supplying side core 24, and is provided so that its central axis is vertical to a separation direction (vertical direction) of the power supplying side resonant coil 23 and the power receiving side resonant coil 31 at the time of supplying power, namely, along the horizontal direction. To both ends of the power supplying side loop antenna 22, the high frequency power supply 21 is connected, and the high frequency power from the high frequency power supply 21 is supplied.

The power supplying side resonant coil 23, as illustrated in FIG. 2, is configured by winding the conductive wire in a solenoidal shape around the power supplying side core 24. That is, the power supplying side resonant coil 23 is disposed on the same axis as the power supplying side loop antenna 22. The power supplying side resonant coil 23 is also provided so that its central axis is vertical to the separation direction (vertical direction) of the power supplying side resonant coil 23 and the power receiving side resonant coil 31 at the time of supplying power, namely, along a horizontal direction. To both ends of the power supplying side resonant coil 23, the power supplying side capacitor C1 for adjusting a resonant frequency is connected.

Further, the power supplying side resonant coil 23, as illustrated in FIG. 2, includes a first power supplying side coil unit 23A and a second power supplying side coil unit 23B disposed side by side on the same axis. The first power supplying side coil unit 23A and the second power supplying side coil unit 23B are provided so that the directions of winding are opposite to each other. The first power supplying side coil unit 23A corresponds to a first coil unit in claims, and the second power supplying side coil unit 23B corresponds to a second coil unit in claims.

The first and second power supplying side coil units 23A, 23B are configured of one conductive wire. In the reference example, the conductive wire is wound counterclockwise toward the second power supplying side coil unit 23B to provide the first power supplying side coil unit 23A, and then is made to perform U-turn and wound in an opposite direction (clockwise) to the first power supplying side coil unit 23A to provide the second power supplying side coil unit 23B. The first and second power supplying side coil units 23A, 23B are provided in the same number of turns. That is, the wire that configures the first power supplying side coil unit 23A and the wire that configures the second power supplying side coil unit 23B are provided in the same length.

The power supplying side loop antenna 22 and the power supplying side resonant coil 23 are provided to be separated from each other in a range in which they can be electromagnetically coupled with each other, namely, in a range in which high frequency power is supplied to the power supplying side loop antenna 22 and, when high frequency current flows, electromagnetic induction is generated to the power supplying side resonant coil 23.

The power supplying side core 24 is configured from a magnetic body such as ferrite, and provided in a substantially flat plate-like shape. The core 24 is disposed horizontally.

The power supplying side shield case 25 is configured from a highly conductive metal shield such as copper and aluminum. The power supplying side shield case 25 is configured of a bottom wall 25A that covers a side away from the power receiving side resonant coil 31 to be described later of the power supplying side loop antenna 22 and power supplying side resonant coil 23, and a standing wall 25B that stands from a peripheral edge of the bottom wall 25A, and is provided in a box shape in which the power receiving unit 3 side is opened. The bottom wall 25A is provided in a slightly larger rectangular shape than the power supplying side core 24. The standing wall 25B is provided to surround the side surface of the power supplying side core 24.

The power receiving unit 3, as illustrated in FIG. 1, includes a power receiving side resonant coil 31 that electromagnetically resonates with the power supplying side resonant coil 23, a power receiving side loop antenna 32 electromagnetically coupled with the power receiving side resonant coil 31, a power receiving side core 33 to which the power receiving side loop antenna 32 and the power receiving side resonant coil 31 are wound (see FIG. 2), a power receiving side capacitor C2 connected across both ends of the power receiving side resonant coil 31, a rectifier 34 that converts the high frequency power received by the power receiving side loop antenna 32 to DC power, a vehicle mounted battery 35 to which the DC power converted by the rectifier 34 is supplied, and a power receiving side shield case 36 for housing the power receiving side loop antenna 32 and the power receiving side resonant coil 31.

The power receiving side resonant coil 31 and the power receiving side loop antenna 32 are provided in the same size and shape as the power supplying side resonant coil 23 and the power supplying side loop antenna 22 described above, respectively, and are provided so that their central axes are vertical to the separation direction (vertical direction) of the power supplying side resonant coil 23 and the power receiving side resonant coil 31, namely, along the horizontal direction. Further, although the power receiving side loop antenna 32 is not illustrated in FIG. 2, the power receiving side resonant coil 31 and the power receiving side loop antenna 32 are wound around the power receiving side core 33, and thus are both disposed on the same axis. Across the both ends of the power receiving side resonant coil 31, a power receiving side capacitor C2 for the resonant frequency is connected.

Further, the power receiving side resonant coil 31, similar to the power supplying side resonant coil 23, as illustrated in FIG. 2, includes a first power receiving side coil unit 31A and a second power receiving side coil unit 31B each disposed on the same axis. The first power receiving side coil unit 31A and the second power receiving side coil unit 31B are provided so that the directions of winding are opposite to each other.

The power receiving side resonant coil 31 is disposed same as a state that the power supplying side resonant coil 23 has been rotated 180 degrees around an axis L1. The axis L1 passes through the axial direction center of the power supplying side resonant coil 23, and is perpendicular to the axial direction and the separation direction of the power supplying side resonant coil 23 and the power receiving side resonant coil 31. As a result, in the power supplying side resonant coil 23, the first power supplying side coil unit 23A is disposed in the left in the figure and the second power supplying side coil unit 23B is disposed in the right in the figure, however, in the power receiving side resonant coil 31, the first power receiving side coil unit 31A is disposed in the right in the figure and the second power receiving side coil unit 31B is disposed in the left in the figure.

Further, the power receiving side resonant coil 31 and the power receiving side loop antenna 32 are provided to be separated from each other in a range in which they are electromagnetically coupled with each other, namely, in a range in which, when AC current flows through the power receiving side resonant coil 31, induction current is generated in the power receiving side loop antenna 32.

The power receiving side shield case 36, as illustrated in FIG. 2, is configured from a highly conductive metal shield such as copper and aluminum in the same manner as the power supplying side shield case 25. The power receiving side shield case 36 is configured of a bottom wall 36A that covers a side away from the power supplying side resonant coil 23 to be described later of the power receiving side loop antenna 32 and the power receiving side resonant coil 31, and a standing wall 36B that stands from a peripheral edge of the bottom wall 36A, and is provided in a box shape in which the power supplying unit 2 side is opened.

The bottom wall 36A is provided in a slightly larger rectangular shape than the power receiving side core 33. The standing wall 36B is provided to surround the side surface of the power receiving side core 33.

According to the contactless power supplying apparatus 1 described above, when the power receiving unit 3 of the vehicle approaches the power supplying unit 2 provided on the ground of the power supplying facility and then the power supplying side resonant coil 23 and the power receiving side resonant coil 31 electromagnetically resonate with each other, power is contactlessly supplied from the power supplying unit 2 to the power receiving unit 3, and the vehicle mounted battery 35 is charged.

In detail, when the AC current is supplied to the power supplying side loop antenna 22, the power is transmitted to the power supplying side resonant coil 23 by electromagnetic induction. That is, to the power supplying side resonant coil 23, the power is supplied via the power supplying side loop antenna 22. When the power is transmitted to the power supplying side resonant coil 23, the power is wirelessly transmitted to the power receiving side resonant coil 31 by resonance of the magnetic field. Furthermore, when the power is transmitted to the power receiving side resonant coil 31, the power is transmitted to the power receiving side loop antenna 32 by electromagnetic induction, and the vehicle mounted battery 35 connected to the power receiving side loop antenna 32 is charged.

Further, according to the embodiment described above, the first power supplying side coil unit 23A and the second power supplying side coil unit 23B are wound in opposite directions to each other. As a result, magnetic flux generated from the first power supplying side coil unit 23A and magnetic flux generated from the second power supplying side coil unit 23B cancel each other, so that a leakage magnetic field that occurs in the periphery can be reduced.

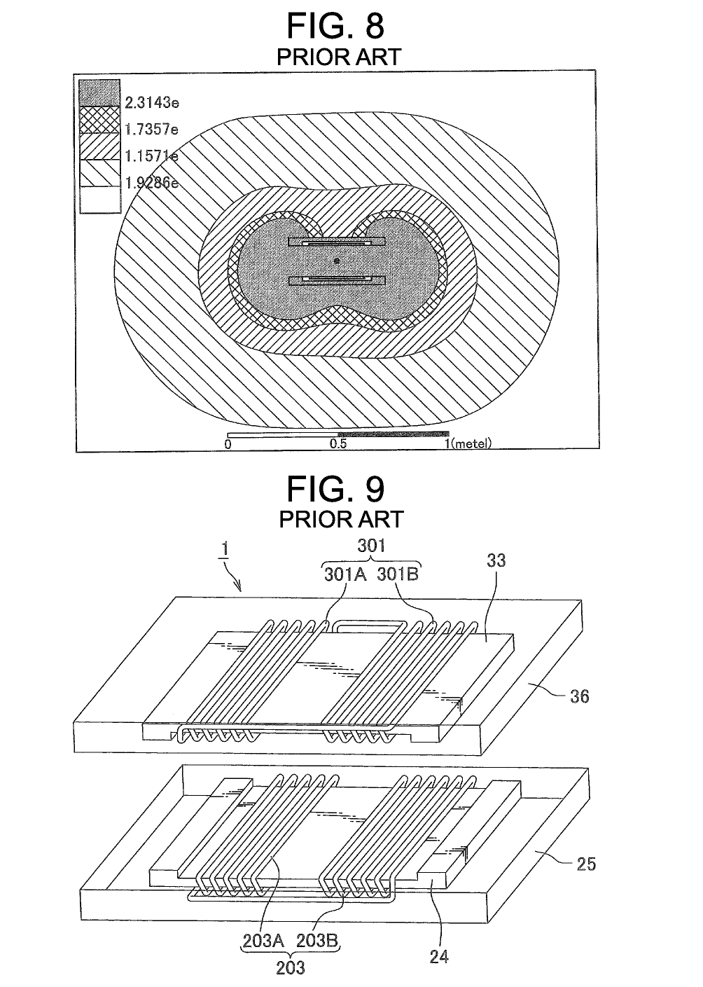

Next, the present inventors, in order to confirm the effect, have performed a simulation of the radiation magnetic field distribution, for a reference product A that is a contactless power supplying apparatus 1 in FIG. 2, and a conventional product that is a contactless power supplying apparatus 1 in which, as illustrated in FIG. 9, the power supplying side resonant coil 203 and the power receiving side resonant coil 301 are wound in the same direction uniformly. The results are illustrated in FIG. 3 and FIG. 8.

Incidentally, in the reference product A, any of the power supplying side resonant coil 23 and the power receiving side resonant coil 31 are set to 11 turns, and any of the first power supplying side coil unit 23A, the second power supplying side coil unit 23B, the first power receiving side coil unit 31A, and the second power receiving side coil unit 31B are set to 5.5 turns. Further, the conventional product is configured as illustrated in FIG. 9. In FIG. 9, equivalent portions with the reference product A illustrated in FIG. 2 is denoted by the same numerals, and detailed descriptions thereof are omitted. As illustrated in FIG. 9, the power supplying side resonant coil 203 and the power receiving side resonant coil 301 of the conventional product, same as the power supplying side resonant coil 23 and the power receiving side resonant coil 31 of the reference product A, are set to 11 turns. However, a first power supplying side coil unit 203A of the power supplying side core 24 wound in the left in the figure and a second power supplying side coil unit 203B wound in the right in the figure are wound in the same direction. Further, a first power receiving side coil unit 301A of the power receiving side core 33 wound in the left in the figure and a second power receiving side coil unit 301B wound in the right in the figure are also wound in the same direction.

As it is apparent from FIG. 9, it has been confirmed that the reference product A can prevent expansion of the leakage magnetic field more than the conventional product.

### First Embodiment

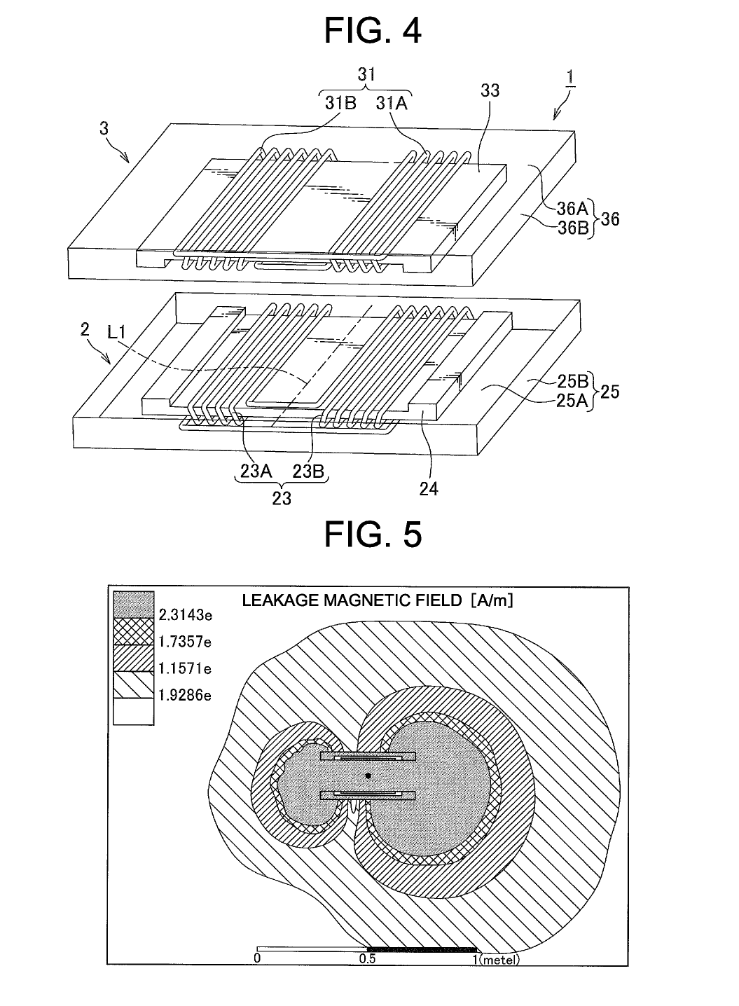

Next, a first embodiment will be described with reference to FIG. 4 and FIG. 5. In the reference example, the number of turns has been the same between the first power supplying side coil unit 23A, the first power receiving side coil unit 31A and the second power supplying side coil unit 23B, the second power receiving side coil unit 31B, however, in the first embodiment, the number of turns are different between the first power supplying side coil unit 23A, the first power receiving side coil unit 31A and the second power supplying side coil unit 23B, the second power receiving side coil unit 31B. In an example illustrated in FIG. 4, the first power supplying side coil unit 23A, the first power receiving side coil unit 31A have been set to 5 turns, and the second power supplying side coil unit 23B, the second power receiving side coil unit 31B have been set to 6 turns.

The power receiving side resonant coil 31, similar to the reference example, is disposed same as the state that the power supplying side resonant coil 23 has been rotated 180 degrees around the axis L1. As a result, similar to the reference example, in the power supplying side resonant coil 23, the first power supplying side coil unit 23A of 5 turns is disposed in the left in the figure and the second power supplying side coil unit 23B of 6 turns is disposed in the right in the figure, and in the power receiving side resonant coil 31, the first power receiving side coil unit 31A of 5 turns is disposed in the right in the figure and the second power receiving side coil unit 31B of 6 turns is disposed in the left in the figure.

According to the first embodiment, since the wire that configures the first power supplying side coil unit 23A and the wire that configures the second power supplying side coil unit 23B are different from each other in length, it is possible to impart directivity to the leakage magnetic field.

Further, according to the first embodiment, by changing the number of turns, it is possible to easily make the lengths of the conductive wires different between the first power supplying side coil unit 23A and the second power supplying side coil unit 23B.

Next, the present inventors have performed a simulation of the radiation magnetic field distribution for the reference product A that is a contactless power supplying apparatus 1 illustrated in FIG. 2 described in the reference example, and a present invention product B that is a contactless power supplying apparatus 1 illustrated in FIG. 4 described in the first embodiment. The results are illustrated in FIG. 3 and FIG. 5.

Incidentally, as described above, in the reference product A, any of the power supplying side resonant coil 23 and the power receiving side resonant coil 31 are set to 11 turns, and any of the first power supplying side coil unit 23A, the second power supplying side coil unit 23B, the first power receiving side coil unit 31A, and the second power receiving side coil unit 31B are set to 5.5 turns. Further, in the present invention product B, any of the power supplying side resonant coil 23 and the power receiving side resonant coil 31 are set to 11 turns, and the first power supplying side coil unit 23A, the first power receiving side coil unit 31A are set to 5 turns, and the second power supplying side coil unit 23B, the second power receiving side coil unit 31B are set to 6 turns.

As illustrated in FIG. 3, in the reference product A, axial direction both sides of the resonant coils 23, 31 have almost the same magnetic field distribution. On the other hand, in the present invention product B, it has been found that the radiation magnetic field is greater in the second power supplying side coil unit 23B side (right in the figure) in which the number of turns is larger than in the first power supplying side coil unit 23A side (left in the figure) in which the number of turns is smaller. That is, it has been found that it is possible to impart directivity to the leakage magnetic field, and beam form is possible. As a result, it is possible to leak the magnetic field to a place where there is no one.

Typically, the wavelength is about 3000 m in the low frequencies around 100 kHz. Although phase adjustment in the length about λ/4 is required for the beam form typically, 750 m is required for that and it is not realistic. However, according to the first embodiment, it has been found that the beam form is easily possible only by changing the number of turns without the phase adjustment.

### Second Embodiment

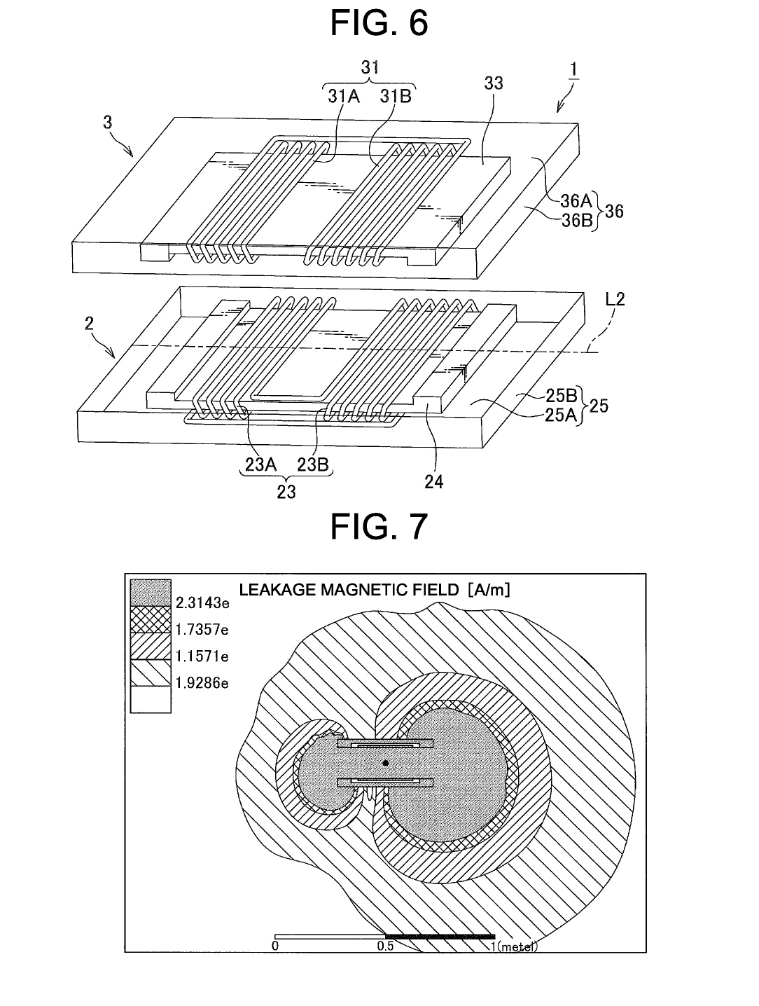

Next, a second embodiment will be described with reference to FIG. 6 and FIG. 7. In the first embodiment, the power receiving side resonant coil 31 is disposed same as the state that the power supplying side resonant coil 23 has been rotated 180 degrees around the axis L1. On the other hand, in the second embodiment, the power receiving side resonant coil 31 is disposed same as a state that the power supplying side resonant coil 23 has been rotated 180 degrees around an axis L2.

As a result, in the power supplying side resonant coil 23, the first power supplying side coil unit 23A of 5 turns is disposed in the left in the figure and the second power supplying side coil unit 23B of 6 turns is disposed in the right in the figure, and in the power receiving side resonant coil 31, similar to the power supplying side resonant coil 23, the first power receiving side coil unit 31A of 5 turns is disposed in the left in the figure and the second power receiving side coil unit 31B of 6 turns is disposed in the right in the figure. When the power receiving side resonant coil 31 is disposed in this way, too, similar to the first embodiment, it is also possible to impart directivity to the leakage magnetic field.

Next, the present inventors have performed a simulation of the radiation magnetic field distribution for a present invention product C that is a contactless power supplying apparatus 1 illustrated in FIG. 6 described in the second embodiment. The result is illustrated in FIG. 7.

Incidentally, in the present invention product C, any of the power supplying side resonant coil 23 and the power receiving side resonant coil 31 are set to 11 turns, and the first power supplying side coil unit 23A and the first power receiving side coil unit 31A are set to 5 turns, and the second power supplying side coil unit 23B and the second power receiving side coil unit 31B are set to 6 turns.

As illustrated in FIG. 7, it has been found that, in the present invention product C, too, the radiation magnetic field is greater in the second power supplying side coil unit 23B side (right in the figure) in which the number of turns is larger than in the first power supplying side coil unit 23A side (left in the figure) in which the number of turns is smaller. That is, it has been found that it is possible to impart directivity to the leakage magnetic field, and beam form is possible.

Incidentally, according to the embodiment described above, although the power receiving side resonant coil 31 has been also configured of the first power receiving side coil unit 31A and the second power receiving side coil unit 31B wound in opposite directions to each other, the present invention is not limited thereto. The power receiving side resonant coil 31 may be those wound in the same direction uniformly.

Further, according to the first and second embodiments, although the lengths of the conductive wires has been made to be different from each other by making the numbers of turns different between the first power supplying side coil unit 23A and the second power supplying side coil unit 23B, the present invention is not limited thereto. For example, the lengths of the wires may be made to be different from each other by making the diameters different between the first power supplying side coil unit 23A and the second power supplying side coil unit 23B.

Further, the embodiments described above have shown merely exemplary form of the present invention, and the present invention is not limited to the embodiments. That is, it can be implemented in various modifications without departing from the gist of the present invention.

### REFERENCE SIGNS LIST

1 contactless power supplying apparatus

23 power supplying side resonant coil (power supplying side coil)

23A first power supplying side coil unit (first coil unit)

23B second power supplying side coil unit (second coil unit)

31 power receiving side resonant coil (power receiving side coil)

What is claimed is:

1. A power supplying side coil that contactlessly supplies power to a power receiving side coil, comprising
a first coil unit and a second coil unit disposed side by side on the same axis,
wherein the first coil unit and the second coil unit are opposite to each other in the direction of winding, and
wherein a wire that configures the first coil unit and a wire that configures the second coil are different from each other in length.

2. The power supplying side coil according to claim 1,
wherein the power supplying side coil and the power receiving side coil are disposed such that their center axes are vertical to a separation direction of the power supplying side coil and the power receiving side coil at the time of supplying power.

3. The power supplying side coil according to claim 2,
wherein the first coil unit and the second coil unit are different from each other in the number of turns.

4. A contactless power supplying apparatus comprising:
a power supplying side coil described in claim 1; and
a power receiving side coil to which power is contactlessly supplied from the power supplying side coil.

5. A contactless power supplying apparatus comprising:
a power supplying side coil described in claim 2; and
a power receiving side coil to which power is contactlessly supplied from the power supplying side coil.
